(19) United States
(12) Patent Application Publication
(10) Pub. No.: US 2011/0221915 A1
(43) Pub. Date: Sep. 15, 2011

(54) IMAGE STABILIZATION MECHANISM AND IMAGING MODULE

(75) Inventors: Hisanori TAKANO, Tokyo (JP); Hiroaki Imagawa, Tokyo (JP)

(73) Assignee: OLYMPUS CORPORATION, Tokyo (JP)

(21) Appl. No.: 13/039,589

(22) Filed: Mar. 3, 2011

(30) Foreign Application Priority Data
Mar. 11, 2010 (JP) 2010-054653

(51) Int. Cl. H04N 5/228

(52) U.S. Cl. 348/208.7; 348/E05.031

(57) ABSTRACT

An image stabilization mechanism is provided with a base unit, a movable unit on which an image pickup device is arranged and which is movable with reference to the base unit, a guide axis to guide the movable unit in a first direction that is an axis direction parallel with an imaging area of the image pickup device, a first drive unit to move the movable unit along the guide axis in the first direction, and a second drive unit to move the guide axis along the base unit in a second direction that is parallel with the imaging area and that intersects with the first direction.

### CROSS-REFERENCE TO RELATED APPLICATIONS

This application claims benefit of Japanese Application No. 2010-054653 filed Mar. 11, 2010, the contents of which are incorporated by this reference.

### BACKGROUND OF THE INVENTION

1. Field of the Invention

The present invention relates to an image stabilization mechanism that performs image stabilization by moving an image pickup device parallel with an imaging area, and relates to an imaging module that includes this image stabilization mechanism.

2. Description of the Related Art

Some image stabilization mechanisms used for imaging devices perform image stabilization by moving an image pickup device in an X-direction and a Y-direction that are parallel with its imaging area.

Such image stabilization mechanisms are known to include a movable body on which an image pickup device is provided, an X-direction guide bar and a Y-direction guide bar that are provided around the movable body, and a number of magnetism generating devices that move the movable body in the XY-direction, which is the guide direction of the guide bars (for example, see Patent Document 1 (Japanese Laid-open Patent Publication No. 2006-208702)).

In the image stabilization mechanism according to the above-mentioned Patent Document 1, an X-direction guide bar and a Y-direction guide bar are provided around a movable body, and a magnetism generating device is provided around these guide bars.

Other types of image stabilization mechanisms are also known, which include a main frame, and an X-direction driving frame and a Y-direction driving frame on one of which an image pickup device is provided, where the driving frames are moved with reference to the main frame with the driving frames being supported by a freely-rotatable ball (for example, see Patent Document 2 (Japanese Laid-open Patent Publication No. 2006-330678) and Patent Document 3 (Japanese Laid-open Patent Publication No. 2006-337987)).

### SUMMARY OF THE INVENTION

An image stabilization mechanism according to the present invention is provided with a base unit, a movable unit on which an image pickup device is arranged and which is movable with reference to the base unit, a guide axis to guide the movable unit in a first direction that is an axis direction parallel with an imaging area of the image pickup device, a first drive unit to move the movable unit along the guide axis in the first direction, and a second drive unit to move the guide axis along the base unit in a second direction that is parallel with the imaging area and that intersects with the first direction.

An imaging module according to the present invention includes the above-described image stabilization mechanism, an image pickup device arranged on a movable unit of the above-described image stabilization mechanism, and an imaging optical system that forms a subject image on the image pickup device.

### BRIEF DESCRIPTION OF DRAWINGS

FIG. 1 is an exploded perspective view of an image stabilization mechanism according to an embodiment of the present invention.

FIG. 2 is a perspective view of an image stabilization mechanism according to an embodiment of the present invention.

FIG. 3 is a plan view of an image stabilization mechanism according to an embodiment of the present invention.

FIG. 4 is a section view of IV-IV of FIG. 3.

FIG. 5 is a section view of V-V of FIG. 3.

FIG. 6 is a section view of VI-VI of FIG. 3.

FIG. 7 is a section view of VII-VII of FIG. 4.

FIG. 8 is a section view of VIII-VIII of FIG. 4.

FIG. 9 is a block diagram illustrating the control structure of an image stabilization mechanism according to an embodiment of the present invention.

FIG. 10 is a schematic section view of a camera module according to an embodiment of the present invention.

FIG. 11 is a schematic perspective view of a camera module according to an embodiment of the present invention.

FIG. 12 is an exploded perspective view of an image stabilization mechanism according to another embodiment of the present invention.

FIG. 13 is a perspective view of an image stabilization mechanism according to another embodiment of the present invention.

FIG. 14 is a plan view of an image stabilization mechanism according to another embodiment of the present invention.

FIG. 15 is a section view of XV-XV of FIG. 14.

FIG. 16 is a section view of XVI-XVI of FIG. 14.

FIG. 17 is a section view of XVII-XVII of FIG. 15.

### DESCRIPTION OF THE PREFERRED EMBODIMENTS

An image stabilization mechanism and imaging module according to an embodiment of the present invention will be described below with reference to the accompanying drawings.

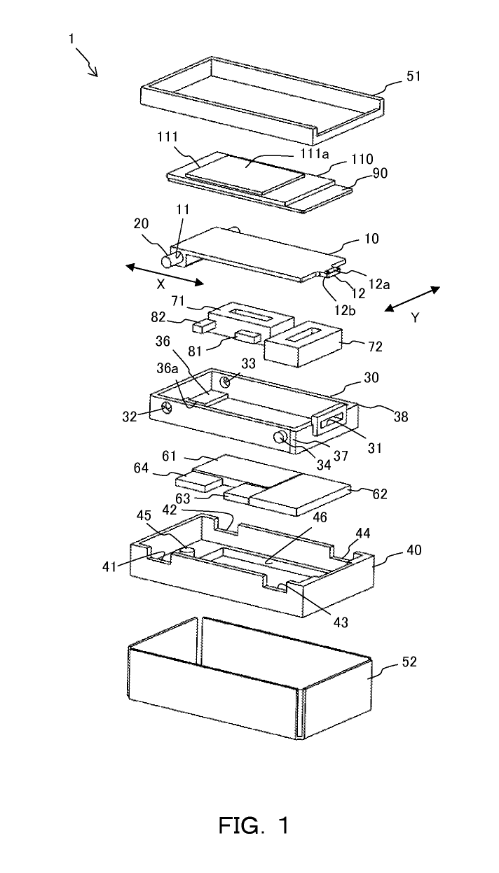

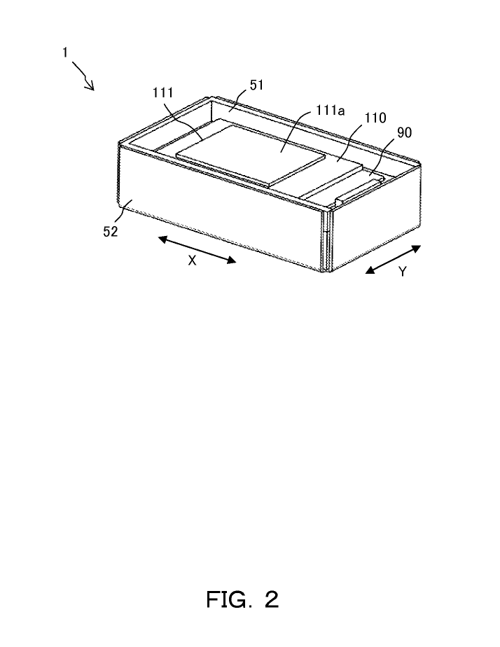

FIGS. 1-3 are an exploded perspective view, a perspective view, and a plan view of an image stabilization mechanism 1 according to an embodiment of the present invention.

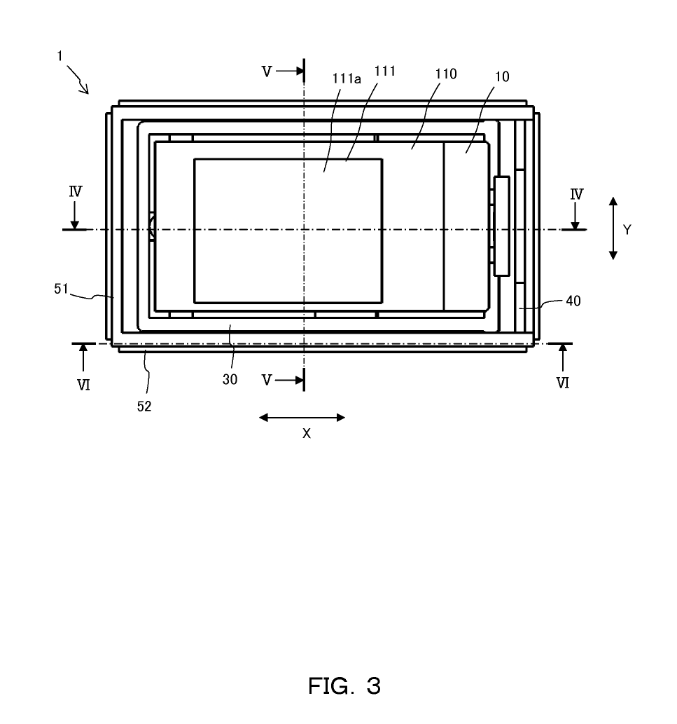

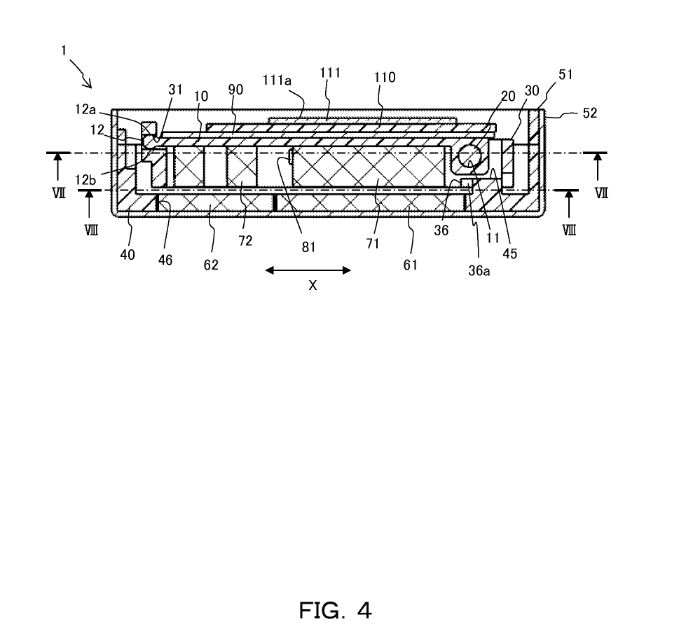

FIGS. 4-6 are a section view of IV-IV of FIG. 3, a section view of V-V of FIG. 3, and a section view of VI-VI of FIG. 3.

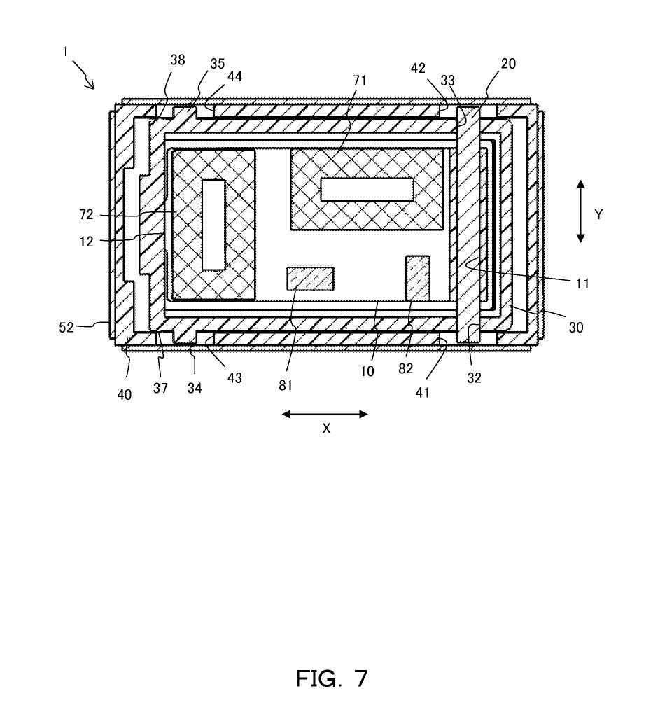

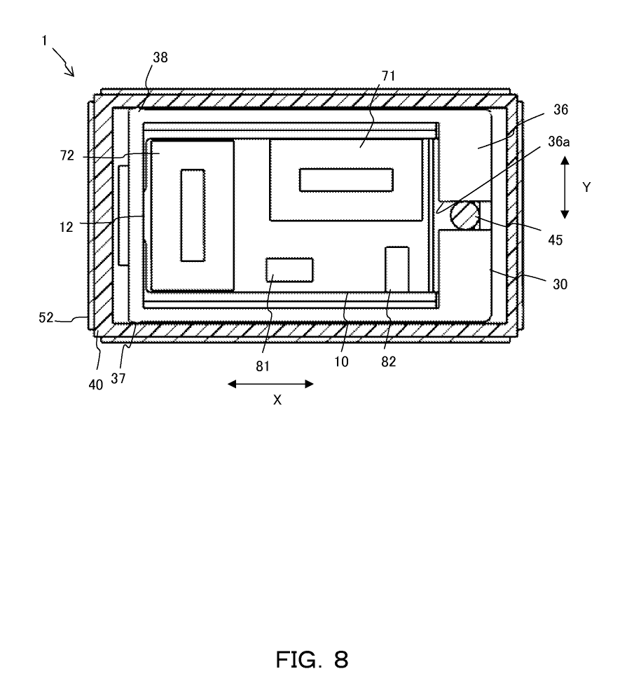

FIGS. 7 and 8 are a section view of VII-VII of FIG. 4, and a section view of VIII-VIII of FIG. 4.

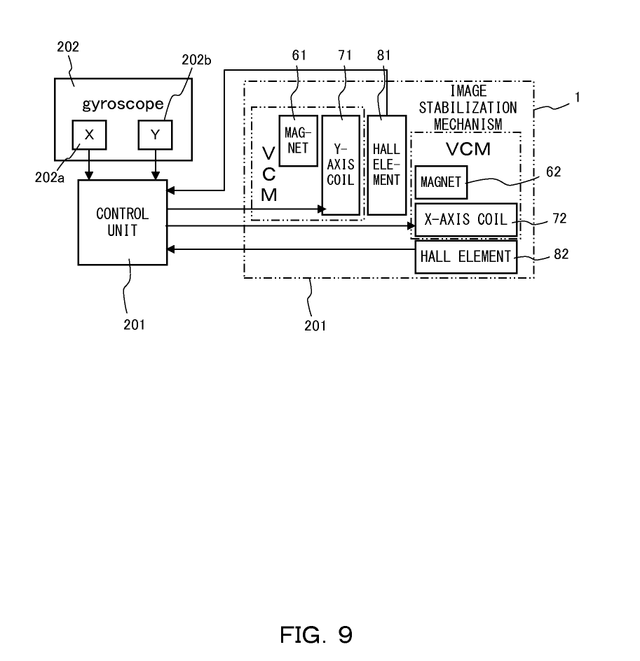

FIG. 9 is a block diagram illustrating the control structure of the image stabilization mechanism 1.

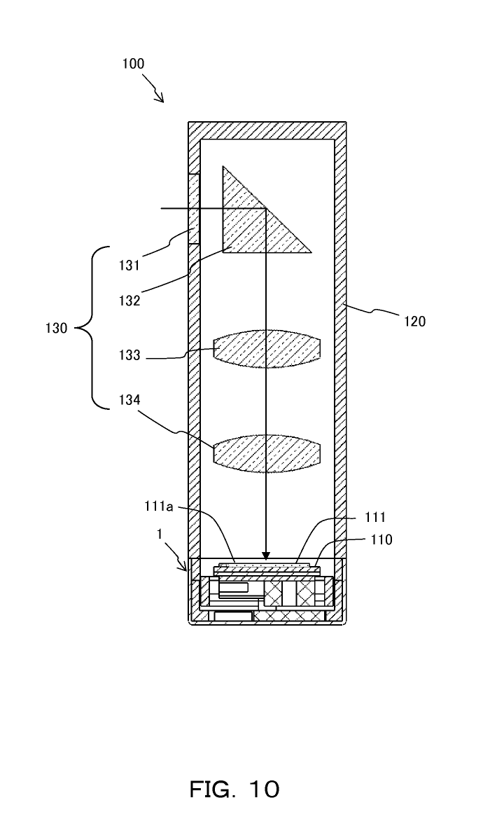

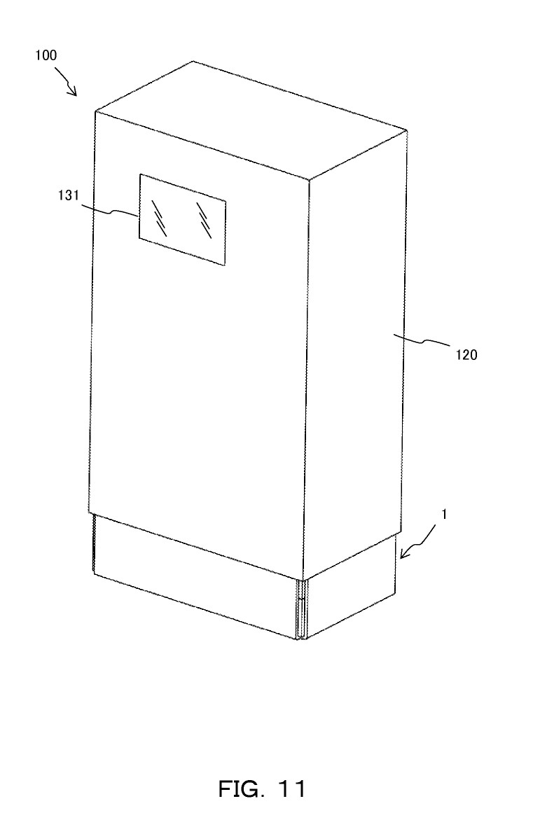

FIGS. 10 and 11 are a schematic section view and schematic perspective view of a camera module 100.

As illustrated in FIG. 1, an image stabilization mechanism 1 is provided with a Y-direction mobile member 10 as a movable unit, a guide axis 20, an X-direction mobile member 30 as a guide unit, a base frame 40 and a top cover 51 as a base unit, a bottom cover 52, a magnet 61 and a Y-axis coil 71 that form a voice coil motor (VCM) as the first drive unit (magnetism generating unit), a magnet 62 and an X-axis coil 72 that form a voice coil motor as the second drive unit (magnetism generating unit), magnets 63 and 64, hall elements 81 and 82, and a yoke 90 as a magnetic material.

On the top face of the Y-direction mobile member 10, the yoke 90 made of, for example, a metal plate is fixed. On the top face of this yoke 90, an image pickup device substrate 110 on which an image pickup device 111 is mounted is provided. At an end of the Y-direction mobile member 10, a through hole 11 is formed in the X-direction (i.e., “second direction” parallel with an imaging area 111a of the image pickup device 111) such that the guide axis 20 penetrates therethrough. Except the portion at which the through hole 11 is formed, the Y-direction mobile member 10 has a plate shape approximately parallel with the imaging area 111a of the image pickup device 111.

On the bottom face of the Y-direction mobile member 10, a Y-axis coil 71, an X-axis coil 72, and hall elements 81 and 82 are fixed so as to be opposed to the four magnets that are fixed to the bottom cover 52.

The Y-direction mobile member 10 is moved by the magnet 61 and the Y-axis coil 71 in the Y-direction, which is the axis direction of the guide axis 20 (“first direction”, which is parallel with the imaging area 111a of the image pickup device 111 and that intersects with the above-mentioned second direction), as will be described later in detail. In other words, the Y-direction mobile member 10 is moved in the Y-direction as guided by the guide axis 20, and thereby the image pickup device 111 on the Y-direction mobile member 10 is moved in the Y-direction.

On the other end (opposite side of the through hole 11) of the Y-direction mobile member 10 in the X-direction, a projecting part 12 whose width in the Y-direction is narrower than the other parts is formed so as to project in the X-direction. This projecting part 12 is inserted into a Y-direction guide hole 31 of the X-direction mobile member 30, as will be described later.

As illustrated in FIGS. 1 and 4, on the top face and bottom face of the projecting part 12, convex portions 12a and 12b are formed. These convex portions 12a and 12b have an approximately hemisphere-shaped section or an approximately semiellipse-shaped section, irrespective of their position in the Y-direction.

As the height of the Y-direction guide hole 31 is approximately the same as that of the projecting part 12, the top end of the convex portion 12a formed on the top face of the projecting part 12 is in line-contact with the Y-direction guide hole 31 in the Y-direction. The bottom end of the convex portion 12b formed on the bottom face of the projecting part 12 is also in line-contact with the Y-direction guide hole 31 in the Y-direction.

The Y-direction guide hole 31 is longer than the projecting part 12 in the Y-direction, and thus when the Y-direction mobile member 10 moves along the guide axis 20 in the Y-direction, the projecting part 12 slides within the Y-direction guide hole 31 with the convex portions 12a and 12b on its top and bottom being in line-contact with the Y-direction guide hole 31. The convex portions 12a and 12b slide in line-contact with the Y-direction guide hole 31 as described above, and thus the sliding resistance between the convex portions 12a and 12b and the Y-direction guide hole 31 can be reduced. Moreover, the movement of the Y-direction mobile member 10 in the height direction is restricted at the convex portions 12a and 12b and the Y-direction guide hole 31 in a similar manner as the guide axis 20. The backlash of the Y-direction mobile member 10 in the height direction is prevented by the yoke 90, as will be described later in detail.

As illustrated in FIGS. 1 and 7, the guide axis 20 fits into the X-direction mobile member 30 by penetrating through holes 32 and 33, thereby integrating with the X-direction mobile member 30. When the guide axis 20 is moved together with the X-direction mobile member 30 in the X-direction by the magnet 62 and the X-axis coil 72, the guide axis 20 slides into rectangular-shaped concave portions (axis guide holes) 41 and 42 formed on the top-face side of the base frame 40 in the X-direction. As the guide axis 20 and the X-direction mobile member 30 move in the X-direction, the image pickup device 111 on the Y-direction mobile member 10 also moves in the X-direction.

Note that the guide axis 20 according to the present embodiment moves along the base frame 40 by sliding into the concave portions 41 and 42 of the base frame 40, but if the guide axis 20 is rotatably supported by the X-direction mobile member 30 via a bearing, the guide axis 20 may be rotated along the base frame 40 (concave portions 41 and 42). In that case, the sliding resistance between the guide axis 20 and the base frame 40 can be reduced.

The X-direction mobile member 30 has a rectangular-shaped frame that is open on both the top face and the bottom face, where the length is longer in the X-direction than in the Y-direction. As illustrated in FIG. 7, auxiliary guide units 34 and 35 are provided for the X-direction mobile member 30 on the opposite side of the guide axis 20 in the X-direction, and these auxiliary guide units 34 and 35 slide on the base frame 40 in a similar manner as the guide axis 20. These auxiliary guide units 34 and 35 are cylindrically shaped protrusions, and are provided so as to protrude to both sides in the Y-direction. In a similar manner as the concave portions 41 and 42 into which the guide axis 20 slides, the auxiliary guide units 34 and 35 also slide into rectangular-shaped concave portions 43 and 44 that are open on the top face of the base frame 40.

The X-direction mobile member 30 is open on the bottom face (and the top face) as described above, and a guide hole forming plate 36 is provided at a portion below the guide axis 20. In order to form an X-direction guide hole 36a that extends in the X-direction, this guide hole forming plate 36 is comprised of two plates that are positioned so as to surround the X-direction guide hole 36a.

When the X-direction mobile member 30 moves in the X-direction with reference to the base frame 40, the X-direction guide hole 36a slides in line-contact with a cylindrically-shaped protrusion 45 that protrudes upward from the base frame 40 in the height direction. Accordingly, the sliding resistance between the X-direction guide hole 36a and the protrusion 45 is reduced due to the line-contact.

As illustrated in FIG. 7, convex portions 37 and 38 are provided on end faces of the X-direction mobile member 30 so as to protrude in the Y-direction across the height direction, and these end faces of the X-direction mobile member 30 are ones on which the auxiliary guide units 34 and 35 are provided in the Y-direction opposite the guide axis 20. These convex portions 37 and 38 have an approximately hemisphere-shaped section or an approximately semiellipse-shaped section irrespective of the position in the height direction, and are in line-contact with the inner surface of the base frame 40.

As described above, the rotation of the X-direction mobile member 30 on the XY-plane is regulated by the protrusion 45 of the base frame 40 as well as the convex portions 37 and 38.

As illustrated in FIG. 1, the base frame 40 has an approximately rectangular-parallelepiped box shape that is open on the top face. On the base frame 40, the concave portions 41-44 that are open on the top face as well as the protrusion 45 that protrudes upward from the bottom face are formed, as described above. Moreover, on the bottom face of the base frame 40, a magnet accommodating hole 46 that accommodates the magnets fixed to the bottom cover 52 is formed.

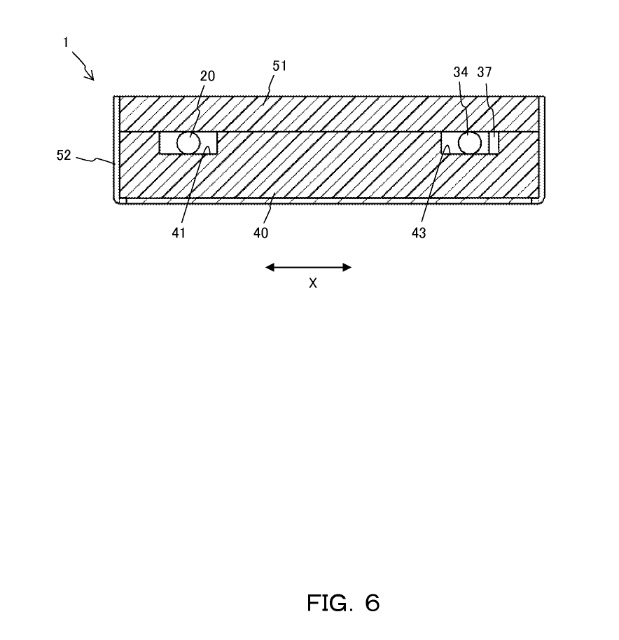

As illustrated in FIG. 6, the guide axis 20 and the auxiliary guide units 34 and 35 are positioned in the concave portions 41-44 of the base frame 40 by the top cover 51 that is arranged above the base frame 40. Note that the axis guide holes (concave portions 41 and 42) may be formed on the top cover 51 (base unit) that is arranged above the base frame 40 (base unit).

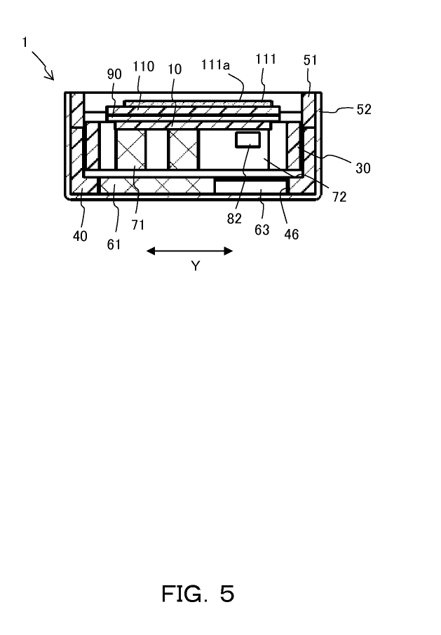

As illustrated in FIGS. 4 and 5, the top cover 51 is fitted into the inner surface of the bottom cover 52, and thereby holds the base frame 40 or the like within the bottom cover 52. Note that the bottom cover 52 is comprised of, for example, metal, and may function as a yoke.

The above-described yoke 90 on which the image pickup device substrate 110 is provided restricts the movement of the Y-direction mobile member 10 in the height direction by being drawn by the magnets 61-64 that are fixed to the bottom cover 52, and thereby positions the Y-direction mobile member 10. In particular, the yoke 90 is drawn downward by the magnets 61-64, and thereby pressurizes the Y-direction mobile member 10 and reduces the backlash of the Y-direction mobile member 10 in the height direction.

In the image stabilization mechanism 1 according to the present embodiment, the coils 71 and 72 are provided for the Y-direction mobile member 10, and the magnets 61-64 are provided for the bottom cover 52. However, when the magnets and the coils are positioned in the opposite manner, i.e., when the magnets 61-64 are fixed to the Y-direction mobile member 10, the bottom cover 52 functions as a magnetic material that is drawn by the magnets 61-64.

A control unit 201 of FIG. 9 detects the amount of camera shaking (angular velocity) of an imaging device (not illustrated) by an X-direction detection unit 202a and a Y-direction detection unit 202b of a gyroscope 202.

The control unit 201 calculates the detected amount of camera shaking as the amount of movement of the image pickup device 111, and feeds electric current that corresponds to the calculated amount of the movement to the Y-axis coil 71 and the X-axis coil 72. Accordingly, the Y-direction mobile member 10 moves along the guide axis 20 in the Y-direction as described above, and the guide axis 20 and the X-direction mobile member 30 move together with the Y-direction mobile member 10 in the X-direction. As a result, the image pickup device 111 arranged on the Y-direction mobile member 10 moves in the Y-direction and the X-direction, as described above.

The hall elements 81 and 82 are arranged so as to be opposed to the magnets 63 and 64, and detect the amount of movement of the image pickup device 111 in the X-direction and the Y-direction by detecting the magnetic field intensity. When the amount of movement of the image pickup device 111 detected by the hall elements 81 and 82 does not match the above-calculated amount of movement, the control unit 201 repeats the operations of feeding electric current to the Y-axis coil 71 and the X-axis coil 72 so as to move the image pickup device 111 and detecting the amount of the movement of the image pickup device 111 by the hall elements 81 and 82.

Note that the first drive unit and the second drive unit are not limited to the magnets 61 and 62 and the Y-axis coil 71 and the X-axis coil 72 (voice coil motors as a magnetism generating unit) and may be other types of drive units, but it is desirable to use a magnetism generating unit if the downsizing of the image stabilization mechanism 1 is planned.

The above-described image stabilization mechanism 1 is arranged, for example, at the bottom of a camera module 100 as an imaging module, as illustrated in FIGS. 10 and 11. This camera module 100 is provided with the image stabilization mechanism 1, the image pickup device 111, a cabinet 120, and a bending optical system 130 as an imaging optical system, as described above, and is provided for, for example, a mobile terminal device such as a mobile phone, or an imaging device such as a digital camera. The bending optical system 130 is provided with optical elements 131-134 such as a lens or a prism, and forms a subject image on the image pickup device 111.

In the above-described present embodiment, the Y-direction mobile member (movable unit) 10 on which the image pickup device 111 is arranged moves along the guide axis 20, and the guide axis 20 moves along the base frame (base unit) 40. In other words, the guide axis 20 guides the Y-direction mobile member 10 in the Y-direction, which is the axis direction of the guide axis 20, and in the X-direction, which intersects with the Y-direction.

Accordingly, the backlash of the Y-direction mobile member 10 is reduced by the guide axis 20, and image stabilization can be securely performed. Moreover, as the guide axis 20 is moved along the base frame 40, the footprint of the image stabilization mechanism 1 can be reduced without enlarging its size in the height direction.

As described above, according to the present embodiment, downsizing of the image stabilization mechanism 1 can be achieved, and image stabilization can be securely performed.

Moreover, in the present embodiment, at least one of the first drive unit (including both the magnet 61 and the Y-axis coil 71) and the second drive unit (including both the magnet 62 and the X-axis coil 72) is used as a magnetism generating unit that has the magnets 61 and 62 such that the yoke (magnetic material) 90 is drawn by the magnets 61 and 62 (63 and 64), and thereby the Y-direction mobile member (movable unit) 10 is positioned.

Accordingly, simplification can be achieved by omitting a member such as a spring so as to reduce the backlash of the Y-direction mobile member 10, and thereby downsizing of the image stabilization mechanism 1 is further achieved.

In the present embodiment, the yoke 90 is drawn by the magnets 61 and 62 (63 and 64), and thereby restricts the movement of the Y-direction mobile member 10 in the height direction (i.e., the direction intersecting with the imaging area 111a). Accordingly, the backlash of the Y-direction mobile member 10 in the height direction is reduced, and image stabilization can be more securely performed.

Moreover, in the present embodiment, the concave portions 41 and 42 (axis guide holes), which are longer than the guide axis 20 in the X-direction, are formed on the base frame 40 (base unit), and the guide axis 20 slides into the concave portions 41 and 42. Accordingly, simplification of the image stabilization mechanism 1 can be further achieved, and downsizing of the image stabilization mechanism 1 can be further achieved.

Moreover, in the present embodiment, the X-direction mobile member (guide unit) 30 on which the guide axis 20 is fixed is provided with auxiliary guide units 34 and 35 that move along the base frame 40 together with the guide axis 20. Accordingly, the backlash of the Y-direction mobile member 10 is reduced by the guide axis 20 without increasing the number of guide axes 20 (there is only one guide axis 20 in the present embodiment), and image stabilization can securely be performed. Note that two or more guide axes 20 may be provided.

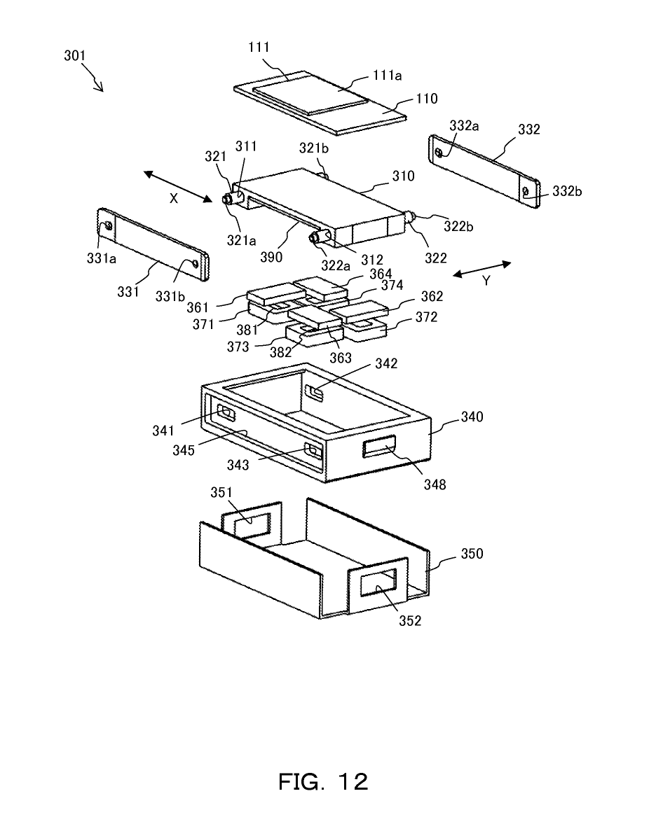

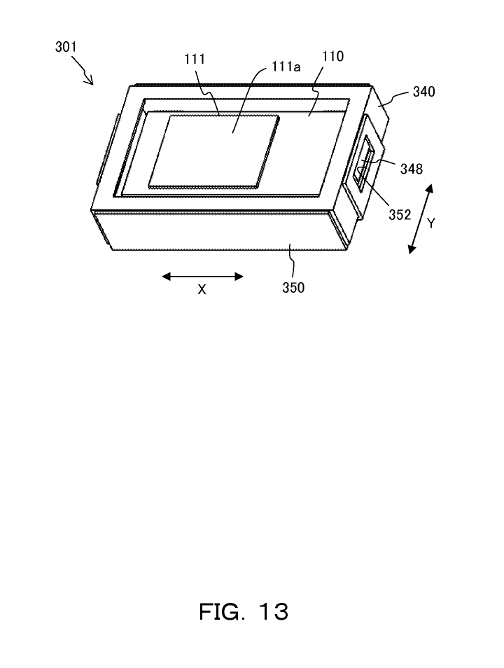

FIGS. 12-14 are, respectively, an exploded perspective view, a perspective view, and a plan view of an image stabilization mechanism 301 according to another embodiment of the present invention.

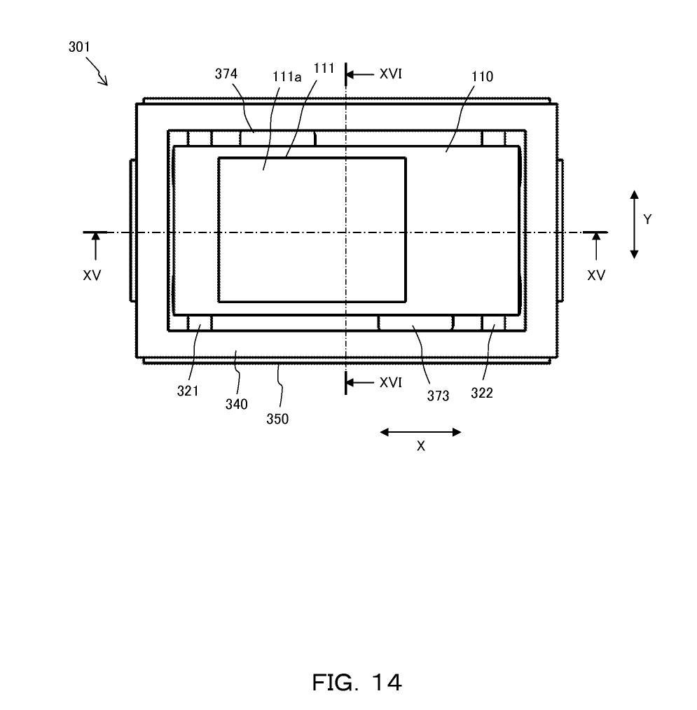

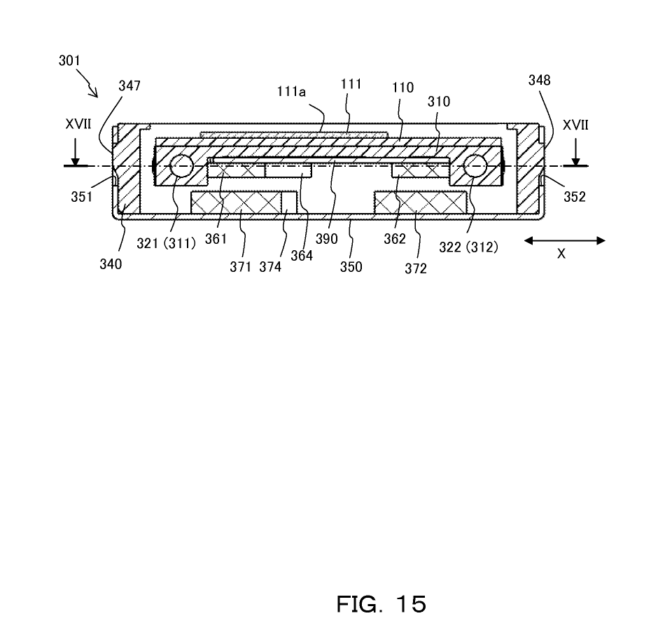

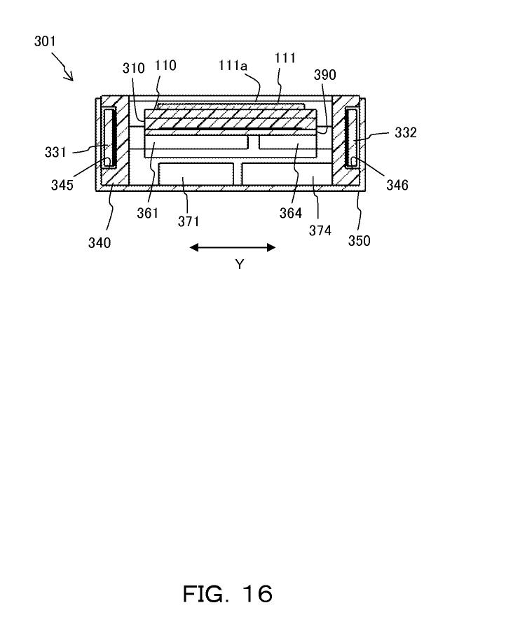

FIG. 15 is a section view of XV-XV of FIG. 14, and FIG. 16 is a section view of XVI-XVI of FIG. 14.

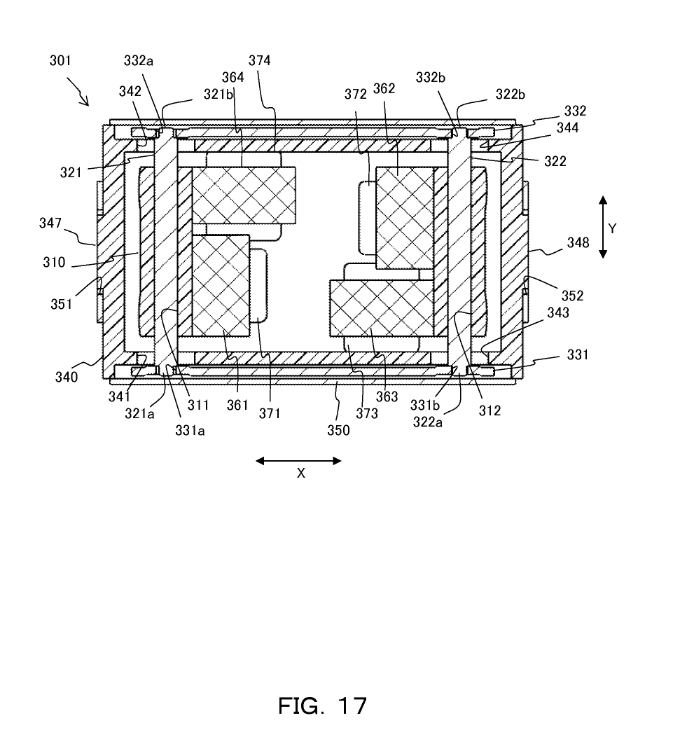

FIG. 17 is a section view of XVII-XVII of FIG. 15.

As illustrated in FIG. 12, the image stabilization mechanism 301 is provided with a Y-direction mobile member 310 as a movable unit, two guide axes 321 and 322, axis linking plates 331 and 332 as an axis linking unit, a base frame 340 as a base unit, and a cover 350 as a magnetic material.

Moreover, the image stabilization mechanism 301 is provided with magnets 361 and 362 and Y-axis coils 371 and 372, which are voice coil motors, as a first drive unit (magnetism generating unit), magnets 363 and 364 and X-axis coils 373 and 374, which are also voice coil motors, as a second drive unit (magnetism generating unit), hall elements 381 and 382, and a yoke 390.

On the top face of the Y-direction mobile member 310, an image pickup device substrate 110 on which an image pickup device 111 is mounted is provided. As illustrated in FIGS. 12 and 17, on both ends of the Y-direction mobile member 310 in the X-direction (i.e., “second direction”, which is parallel with the imaging area 111a of the image pickup device 111), through holes 311 and 312 are provided such that guide axes 321 and 322 penetrate therethrough.

Except for the portion at which the through holes 311 and 312 are formed, the Y-direction mobile member 310 has a plate shape that is approximately parallel with the imaging area 111a of the image pickup device 111. On the bottom face of the Y-direction mobile member 310, a yoke 390 is fixed between the through holes 311 and 312, as will be described later in detail.

On the bottom face of the yoke 390, magnets 361-364 are fixed so as to be opposed to the Y-axis coils 371 and 372 and the X-axis coils 373 and 374 that are fixed to the cover 350. The Y-direction mobile member 310 is moved by the magnets 361 and 362 and the Y-axis coils 371 and 372 along the guide axes 321 and 322 in the Y-direction (i.e., “first direction”, which is parallel with the imaging area 111a of the image pickup device 111 and that intersects with the above-mentioned second direction (X-direction)). Accordingly, the image pickup device 111 on the Y-direction mobile member 310 moves in the Y-direction.

As illustrated in FIGS. 12 and 17, the guide axes 321 and 322 are arranged so as to be parallel with each other. The guide axes 321 and 322 are linked to each other by the axis linking plates 331 and 332 on both ends. At fit holes 331a and 331b, one side of the axis linking plate 331 fits into small diameters 321a and 322a that are formed on the ends of the guide axes 321 and 322 on one side.

At fit holes 332a and 332b, the other side of the axis linking plate 332 fits into small diameters 321b and 322b formed on the ends of the guide axes 321 and 322 on one side.

The tolerance between the guide axes 321 and 322 is considered, and the fit holes 331a and 332a of the axis linking plates 331 and 332 on one side are longer in the X-direction than the than fit holes 331b and 332b on the other side. Note that the height of the fit holes 331a, 331b, 332a, and 332b is approximately the same as that of the guide axes 321 and 322 so as to restrict the movement of the Y-direction mobile member 310 in the Y-direction.

As illustrated in FIG. 12, the base frame 340 has a rectangular-shaped frame that is open on both the top face and the bottom face and in which the X-direction is longer than the Y-direction. On both ends of the base frame 340 in the Y-direction, through holes 341-344 are formed as axis guide holes. The guide axes 321 and 322 slide into the through holes 341-344 in the X-direction in proximity to both ends.

Moreover, on both ends of the base frame 340 in the Y-direction, guide concave portions 345 and 346 that slide the axis linking plates 331 and 332 in the X-direction are formed. Accordingly, the axis linking plates 331 and 332 slide into the guide concave portions 345 and 346 in the X-direction when the guide axes 321 and 322 slide into the through holes 341-344 in the X-direction. As the guide axes 321 and 322 move along the base frame 340 in the X-direction as described above, the image pickup device 111 on the Y-direction mobile member 310 is moved in the X-direction.

At least one of a pair of the guide axes 321 and 322 and a pair of the axis linking plates 331 and 332 slide along the base frame 340 (including the through holes 341-344 and the guide concave portions 345 and 346) in the state in which the movement in the height direction and the rotational direction on the XY-plane is regulated, and thereby the movement of the Y-direction mobile member 310 in the height direction as well as the rotation of the Y-direction mobile member 310 on the XY-plane is prevented.

In the present embodiment, the cover 350 functions as a magnetic material that is drawn by the magnets 361-364. Accordingly, the magnets 361-364 on the side of the movable unit (Y-direction mobile member 310) are drawn downward to the cover 350. As a result, the backlash of the Y-direction mobile member 310 to which the magnets 361-364 are fixed is reduced in the height direction.

As illustrated in FIGS. 12, 15, and 17, convex portions 347 and 348 provided on both ends of the base unit 340 in the X-direction are inserted into through holes 351 and 352 that are provided on both sides of the cover 350 in the X-direction. Accordingly, the base unit 340 is positioned with reference to the cover 350. Note that the cover 350 has an approximately rectangular-parallelepiped box shape that is open on the top face, and is comprised of, for example, a metal; accordingly, the cover 350 functions as a magnetic material that is drawn by the magnets 361-364.

In the image stabilization mechanism 301 according to the present embodiment, the magnets 361-364 are provided on the Y-direction mobile member 310, and the Y-axis coils 371 and 372 and the X-axis coils 373 and 374 are provided on the cover 350. However, if the positional relationship between the magnets and the coils are in reverse, i.e., when the magnets 361-364 are fixed to the cover 350, the yoke 390 that is fixed to the bottom face of the Y-direction mobile member 310 and that is made of, for example, a metal plate, functions as a magnetic material that is drawn by the magnets 361-364.

The hall elements 381 and 382 are arranged inside the Y-axis coil 371 and the X-axis coil 373, and are arranged so as to be opposed to magnets 361 and 363 in a similar manner as the Y-axis coil 371 and the X-axis coil 373.

Also in the present embodiment, the control unit 201, the gyroscope 202 or the like of FIG. 9, feeds electric current to the Y-axis coils 371 and 372 and the X-axis coils 373 and 374, and the image pickup device 111 moves in the X-direction and the Y-direction, in a similar manner as in the previous embodiment.

Also in the present embodiment, the first drive unit and the second drive unit are not limited to the magnets 361-364 or as the Y-axis coils 371 and 372 and the X-axis coils 373 and 374 (voice coil motors as a magnetism generating unit), and may be other types of drive units. The image stabilization mechanism 301 is arranged on, for example, the bottom of the camera module 100 of FIG. 10, in a similar manner as the image stabilization mechanism 1 according to the previous embodiment. Three or more guide axes 321 and 322 may be provided.

Also in the image stabilization mechanism 301 according to the above-described present embodiment, the Y-direction mobile member (movable unit) 310 on which the image pickup device 111 is arranged moves along the guide axes 321 and 322, and the guide axes 321 and 322 move along the base frame (base unit) 340, in a similar manner as the image stabilization mechanism 1 according to the previous embodiment. In other words, the guide axes 321 and 322 guide the Y-direction mobile member 310 in the Y-direction, which is its axis direction, and in the X-direction, which intersects with this Y-direction.

Accordingly, the backlash of the Y-direction mobile member 310 is reduced by the guide axes 321 and 322, and image stabilization can more securely be performed. Moreover, as the guide axes 321 and 322 are moved along the base frame 340, the footprint of the image stabilization mechanism 301 can be reduced without enlarging its size in the height direction.

As described above, also according to the present embodiment, downsizing of the image stabilization mechanism 301 can be achieved, and image stabilization can be securely performed.

In the present embodiment, at least one of the first drive unit (the magnets 361 and 362 and the Y-axis coils 371 and 372) and the second drive unit (the magnets 363 and 364 and the X-axis coils 373 and 374) is used as a magnetism generating unit that has the magnets 361-364 such that the cover 350 as a magnetic material is drawn by the magnets 361-364, and thereby the Y-direction mobile member (movable unit) 310 is positioned.

Accordingly, the image stabilization mechanism 301 can be further simplified, and downsizing of the image stabilization mechanism 301 is further achieved.

In the present embodiment, the cover 350 as a magnetic material is drawn by the magnets 361-364, and thereby restricts the movement of the Y-direction mobile member 310 in the height direction (i.e., the direction intersecting with the imaging area 111a). Accordingly, the backlash of the Y-direction mobile member 310 in the height direction is reduced, and image stabilization can more securely be performed.

Moreover, in the present embodiment, the through holes (axis guide holes) 341-344, which are longer than the guide axes 321 and 322 in the X-direction, are formed on the base frame 340 (base unit), and the guide axes 321 and 322 slide into the through holes 341-344 in the X-direction. Accordingly, simplification of the image stabilization mechanism 301 can be further achieved, and downsizing of the image stabilization mechanism 301 is further achieved.

Moreover, in the present embodiment, the image stabilization mechanism 301 is provided with a plurality of guide axes 321 and 322 that are arranged so as to be parallel with each other. Accordingly, image stabilization can be more securely performed.

Moreover, in the present embodiment, the axis linking plates (axis linking units) 331 and 332 that link the plurality of guide axes 321 and 322 move along the base frame (base unit) 340 together with the guide axes 321 and 322. Accordingly, simplification of the image stabilization mechanism. 301 can be further achieved, and downsizing of the image stabilization mechanism 301 is further achieved.

Note that hatching is used to indicate sections in FIGS. 4-8, 10, and 15-17, but the materials of each part are not limited by the types of hatching. For example, the Y-direction mobile members 10 and 310, the X-direction mobile member 30, the base frames 40 and 340, the top cover 51, the cabinet 120 or the like are made of plastic in this example, but may be made of other materials. Moreover, the guide axes 20, 321, and 322, the bottom cover 52, the cover 350, the axis linking plate 331 and 332, or the like are made of metal in this example, but may be made of other materials.

What is claimed is:

1. An image stabilization mechanism comprising:
a base unit;
a movable unit on which an image pickup device is arranged and which is movable with reference to the base unit;
a guide axis to guide the movable unit in a first direction that is an axis direction parallel with an imaging area of the image pickup device;
a first drive unit to move the movable unit along the guide axis in the first direction; and
a second drive unit to move the guide axis along the base unit in a second direction that is parallel with the imaging area and that intersects with the first direction.

2. The image stabilization mechanism according to claim 1, wherein
at least one of the first drive unit and the second drive unit is provided with a magnetism generating unit having a magnet, and
the image stabilization mechanism further comprises a magnetic material to position the movable unit by drawing the magnet against each other.

3. The image stabilization mechanism according to claim 2, wherein
the magnetic material restricts movement of the movable unit in a direction intersecting with the imaging area by being drawn by the magnet against each other.

4. The image stabilization mechanism according to claim 1, wherein
an axis guide hole that is longer than the guide axis in the second direction is formed on the base unit, and
the second drive unit slides the guide axis into the axis guide hole.

5. The image stabilization mechanism according to claim 1, further comprising a guide unit to which the guide axis is fixed, wherein
the guide unit has an auxiliary guide unit that moves along the base unit together with the guide axis.

6. The image stabilization mechanism according to claim 1, wherein
a plurality of the guide axes are arranged so as to be parallel with each other.

7. The image stabilization mechanism according to claim 6, further comprising an axis linking unit to link the plurality of guide axes, wherein
the axis linking unit moves along the base unit together with the guide axis.

8. An imaging module, comprising:
an image stabilization mechanism according to claim 1;
an image pickup device that is arranged on a movable unit of the image stabilization mechanism; and
an imaging optical system to form a subject image on the image pickup device.

9. The image stabilization mechanism according to claim 8, wherein
at least one of the first drive unit and the second drive unit is provided with a magnetism generating unit having a magnet, and
the image stabilization mechanism further comprises a magnetic material to position the movable unit by drawing the magnet against each other.

10. The image stabilization mechanism according to claim 9, wherein
the magnetic material restricts movement of the movable unit in a direction intersecting with the imaging area by being drawn by the magnet against each other.

11. The image stabilization mechanism according to claim 8, wherein
an axis guide hole that is longer than the guide axis in the second direction is formed on the base unit, and
the second drive unit slides the guide axis into the axis guide hole.

12. The image stabilization mechanism according to claim 8, further comprising a guide unit to which the guide axis is fixed, wherein
the guide unit has an auxiliary guide unit that moves along the base unit together with the guide axis.

13. The image stabilization mechanism according to claim 8, wherein
a plurality of the guide axes are arranged so as to be parallel with each other.

14. The image stabilization mechanism according to claim. 13, further comprising an axis linking unit to link the plurality of guide axes, wherein
the axis linking unit moves along the base unit together with the guide axis.
